(19) United States
(12) Patent Application Publication
(10) Pub. No.: US 2023/0166788 A1
(43) Pub. Date: Jun. 1, 2023

(54) STEERING SYSTEM CIRCUIT ARRANGEMENT, ELECTROMECHANICAL STEERING SYSTEM AND METHOD FOR PRODUCING AND OPERATING AN ELECTROMECHANICAL STEERING SYSTEM

(71) Applicants: thyssenkrupp Presta AG, Eschen (LI); thyssenkrupp AG, Essen (DE)

(72) Inventor: Gergely HORVATH, Fueloepszállás (HU)

(73) Assignees: thyssenkrupp Presta AG, Eschen (LI); thyssenkrupp AG, Essen (DE)

(21) Appl. No.: 18/070,607

(22) Filed: Nov. 29, 2022

(30) Foreign Application Priority Data
Nov. 29, 2021 (DE) 10 2021 213 440.8

(51) Int. Cl. B62D 5/04

(52) U.S. Cl. CPC B62D 5/046; B62D 5/0484

(57) ABSTRACT

A steering system circuit arrangement for operating an electric motor comprised by a steering adjuster may include a control unit and either a first sensor unit, which is designed to provide first input signals, or a second sensor unit, which is designed to provide second input signals that are different from the first input signals. The control unit is configured to both receive the first input signals provided by the first sensor unit and to provide an actuation signal for the electric motor by taking account of these received first input signals, and to receive the second input signals provided by the second sensor unit and to provide the actuation signal by taking account of these received second input signals. Further, an electromechanical steering system may include such a circuit arrangement. Methods for producing and operating such steering systems may also be utilized.

### CROSS REFERENCE TO RELATED APPLICATION

This application is a U.S. Non-Provisional Application that claims priority to German Patent Application No. DE 10 2021 213 440.8, filed Nov. 29, 2021, the entire contents of which are incorporated herein by reference.

### FIELD

The present disclosure generally relates to steering system circuit arrangements, electromechanical steering systems, methods for producing an electromechanical steering system, and methods for operating an electromechanical steering system.

### BACKGROUND

An electromechanical steering system is described in the prior art, for example in DE 10 2018 123 294 A1. An electromechanical steering system comprises a steering shaft, by way of which a steering command is able to be predefined by means of a steering handle, and a steering adjuster, which is designed to convert a steering command into a steering movement for steerable wheels of a motor vehicle by taking account of at least one input variable, in particular an actuation signal. The at least one input variable is used to control the electric motor of the steering adjuster. It is known practice to take account of the steering angle of the steered wheels of the motor vehicle as input signal when ascertaining the input variable.

A method for continually determining a steering angle of the steered wheels of a motor vehicle is described in DE 10 2013 104 586 B4. In this case, the steering angle, or a variable characterizing the steering angle, is determined by using a rotor position sensor, the rotor position sensor providing the position of the motor shaft, in particular a change in the rotor position angle, of the electric motor of the steering adjuster. The signals from the rotor position sensor are then used as input signals for determining the actuation signal.

DE 10 2006 042 104 B4 moreover discloses an electromechanical steering system for a motor vehicle, in which the rotational movement of the motor shaft of the electric motor when the vehicle is in an inoperative situation is recorded using a sleep mode counter. A recorded rotational movement such as this is then taken into account as a further input signal when determining the actuation signal.

It is not obligatory to provide such a sleep mode counter, however. Rather, there are different requirements from different vehicle manufacturers regarding which input signals need to be taken into account for determining the actuation signal. The decision concerning which input signals should be taken into account is dependent in particular on which functions the electromechanical steering system is meant to provide. In addition, cost aspects are also a factor, because the number of sensors for providing input signals affects the level of costs for producing the electromechanical steering system.

It is therefore known practice to provide electromechanical steering systems that have different sensor units depending on the requirements. A disadvantage of this is that using different sensor units, which provide different input signals in particular in respect of the number or type of measured variables recorded, necessitates complex adjustments for the overall system, but at least for the steering system circuit arrangement, in particular necessitates that the control unit that processes the input signals and generates the actuation signal be configured in a manner tailored to the respective sensor unit in each case.

Thus a need exists for a steering system circuit arrangement and an electromechanical steering system, in particular in respect of improved adjustability for different requirements for the steering system, and advantageously in respect of a reduction in configuration complexity.

### BRIEF DESCRIPTION OF THE FIGURES

FIG. 1A is a block diagram representing an exemplary embodiment of a steering system circuit arrangement.

FIG. 1B is a simplified block diagram representing a further exemplary embodiment of a steering system circuit arrangement.

FIG. 1C is a simplified block diagram representing a further exemplary embodiment of a steering system circuit arrangement.

FIG. 2A is a simplified block diagram representing an exemplary embodiment of an integrated circuit for use in a steering system circuit arrangement for actuating one electric motor.

FIG. 2B is a simplified block diagram representing a further exemplary embodiment of an integrated circuit for use in a steering system circuit arrangement for actuating one electric motor.

FIG. 3 is a simplified block diagram representing a further exemplary embodiment of an integrated circuit for use in a steering system circuit arrangement for actuating two electric motors.

FIG. 4 is a simplified block diagram representing a further exemplary embodiment of an integrated circuit for use in a steering system circuit arrangement for actuating two electric motors.

FIG. 5 is a simplified perspective view of an exemplary embodiment of an electromechanical steering system.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The present disclosure generally concerns steering system circuit arrangements, electromechanical steering systems, methods for producing an electromechanical steering system, and methods for operating an electromechanical steering system. More specifically, in some respects, the present disclosure relates to steering system circuit arrangement for operating at least one electric motor comprised by a steering adjuster, the steering system circuit arrangement comprising a control unit that is designed to receive provided input signals and to provide an actuation signal for the at least one electric motor by taking account of the received input signals. Likewise, in some respects, the present disclosure relates to a method for producing an electromechanical steering system and to a method for operating an electromechanical steering system. Instead of the term steering system circuit arrangement, just the shortened expression circuit arrangement is also used below. Various exemplary, advantageous configurations are described below and represented in the figures.

One proposed solution of the present disclosure provides for a steering system circuit arrangement for operating at least one electric motor comprised by a steering adjuster, the steering system circuit arrangement comprising a control unit, in particular an appropriately configured microcontroller unit, that is designed to receive provided input signals and to provide an actuation signal for the at least one electric motor by taking account of the received input signals. In addition, the circuit arrangement has a first sensor unit, which is designed to provide first input signals, or the circuit arrangement has a second sensor unit, which is designed to provide second input signals, which are different from the first input signals. According to the present disclosure, the control unit of the circuit arrangement is both designed to receive the first input signals provided by the first sensor unit and to provide the actuation signal by taking account of these received first input signals, and designed to receive the second input signals provided by the second sensor unit and to provide the actuation signal by taking account of these received second input signals.

In particular, the control unit has the same software, the same safety functions and/or the same hardware regardless of whether the circuit arrangement comprises the first sensor unit or the second sensor unit. As such, advantageously no adjustment of the control unit is necessary when using different sensor units, that is to say in particular sensor units that are not the same. If it was previously necessary, were the circuit arrangement to have a first sensor unit, to also provide a first control unit adjusted for the first sensor unit, in particular adjusted for the first sensor unit in respect of signal processing, and then, were the circuit arrangement to have a second sensor unit, to also provide a second control unit adjusted for the second sensor unit, in particular adjusted for the second sensor unit in respect of signal processing, the present disclosure advantageously allows the same control unit to be used. Manual adjustment for the respective sensor unit is advantageously dispensed with, thereby reducing configuration complexity.

Advantageously, the control unit of the circuit arrangement is a modular control unit that is advantageously configured to interact with a predefined selection of sensor units, in particular the first sensor unit and the second sensor unit, in particular without this requiring further adjustments to be made. Even if this modular control unit sometimes contributes to higher costs than a previously used control unit that needs to be adjusted for the respective sensor unit in each case, the higher costs for the modular control unit are advantageously more than compensated for by the reduced configuration complexity.

Another advantage of the proposed steering system circuit arrangement is the provision of sensor units that in particular may comprise multiple sensors and in particular may be designed to provide input signals representing multiple measured variables. Advantageously, however, the sensor units mean that there are not a multiplicity of sensors needing to be individually connected to the circuit arrangement, which multiplicity varies in respect of the number of predefined input signals to be provided, and transmitting the input signals to the control unit requires the provision of respective signal connections for transmitting the input signals to the control unit, but rather, advantageously, only the one sensor unit needs to be exchanged.

In particular, there is provision for of the second input signals provided by the second sensor unit to differ from the first input signals provided by the first sensor unit at least partially in respect of the number and/or in respect of the representing measured variable and/or in respect of the type of output. In particular, there is provision for the second sensor unit to be designed to provide more input signals than the first sensor unit, to which end there may in particular be provision for the second sensor unit to have more sensors than the first sensor unit. In particular, however, there may also be provision for the second sensor unit to comprise a computing unit that is used to process sensor values recorded by the second sensor unit, the processed sensor values being provided as further input signals. With regard to the difference in respect of the representing measured variable, there may in particular be provision for the first sensor unit to be designed to provide input signals representing a first measured variable, and for the second sensor unit to be designed to provide input signals representing this first measured variable and in addition a second measured variable. With regard to the type of output, there is in particular provision for this to differ in respect of an analogue and a digital output. One configuration variant advantageously provides for the first sensor unit to be designed to provide first input signals in analogue form, whereas the second sensor unit is designed to provide input signals corresponding to these first input signals likewise in analogue form and in addition to provide further input signals in digital form.

A particularly preferred configuration provides for the second input signals provided by the second sensor unit to comprise input signals corresponding to the first input signals and further input signals. The second sensor unit therefore advantageously provides an increased scope of functions compared to the first sensor unit, in particular an expanded number of input signals representing measured variables. As already explained, this advantageously has no effect on the configuration of the control unit, which advantageously remains unchanged regardless of whether the first sensor unit or the second sensor unit is used in the circuit arrangement.

According to a particularly advantageous embodiment, there is provision for the first sensor unit and the second sensor unit each to be designed to provide a signal representing a position of a motor shaft, in particular a motor shaft of the at least one electric motor of the steering adjuster, as first input signals and as input signals corresponding to the first input signals, respectively. In particular, the signal representing a position of a motor shaft is a signal relating to a rotor angle, or a signal relating to a change of rotor position, in particular a signal determined by a rotor position sensor. In particular, the first sensor unit and the second sensor unit each comprise a rotor position sensor for this purpose.

One advantageous development provides for the second sensor unit to further be designed to provide a number of revolutions of a motor shaft as further input signals. In particular, the number of revolutions of the motor shaft is an absolute number of revolutions of the motor shaft. In particular, the second sensor unit may comprise a sensor arrangement having a torque sensor unit and an index sensor unit, in particular as described in DE 10 2020 116 863.2.

According to a further advantageous configuration of the steering system circuit arrangement, the control unit of the circuit arrangement is designed to use the further input signals provided by the second sensor unit to perform a function check, in particular a plausibility check. In particular, there is provision in this regard for the further input signals to relate to an absolute number of revolutions of the motor shaft. Advantageously, the control unit is designed to detect a malfunction when the number of revolutions is no longer received as a provided input signal, in particular although applicable values were provided previously. Further, there is advantageously provision for the control unit, for the purpose of the plausibility check on the provided number of revolutions of the motor shaft, to compare the currently received value for the number of revolutions of the motor shaft with the last received value for the number of revolutions of the motor shaft. If the current value is lower than a most recently received value, the control unit advantageously detects an operational fault.

A particularly advantageous configuration provides for the steering system circuit arrangement to have an integrated circuit (IC), the integrated circuit comprising the first sensor unit or the second sensor unit. In particular, there is provision for the integrated circuit having the second sensor unit to correspond to the integrated circuit having the first sensor unit, expanded with appropriate functions, or appropriate input signals.

The integrated circuit advantageously comprises defined connections, in particular defined outputs, for providing the first input signals or the second input signals, in particular defined outputs for providing the first input signals or the second input signals corresponding to the first input signals, and advantageously defined outputs for providing the further input signals. The association of the input signals with the outputs is advantageously stored in the control unit and/or firmly predefined. The defined connections advantageously likewise comprise connections for supplying power to the circuit.

In one advantageous development, the integrated circuit comprising the second sensor unit has an interface for providing further second input signals, in particular an interface for providing the further input signals, that is to say those input signals that go beyond the input signals corresponding to the first input signals. In particular, there is provision for the interface to be used to provide the number of revolutions of the motor shaft as an input signal. In particular, the interface is one of the following interfaces: serial peripheral Interface (SPI), single edge nibble transmission (SENT) or short PWM code (SPC).

Further advantageously, the control unit of the circuit arrangement is designed to detect whether the circuit arrangement comprises the first sensor unit or the second sensor unit. In particular, the control unit of the circuit arrangement is designed to detect whether the integrated circuit comprises the first sensor unit or the second sensor unit. Advantageously, the control unit is designed to perform an initialization, the initialization involving checking whether the first input signals or the second input signals are provided. If only the first input signals are provided, the control unit advantageously detects the first sensor unit. If the second input signals are provided, the control unit advantageously detects the second sensor unit. In particular, there is provision for the control unit to further be designed to transmit a request to the sensor unit, or the integrated circuit that comprises the sensor unit, of the circuit arrangement for provision of input signals that go beyond the first input signals. Advantageously, the control unit is further designed so as, if a response to the request is not received, to provide the actuation signal by taking account of the first input signals and, if a response is received, to provide the actuation signal by taking account of the second input signals, that is to say in particular the further input signals that go beyond the first input signals in addition to the input signals corresponding to the first input signals. In particular, the control unit transmits a data block, or a data packet, as the request. This process may, like the initialization, take place at a single time, in particular repeatedly in order to avoid transmission errors. In particular, however, there may also be provision for this process to be performed at every service appointment for the motor vehicle or whenever the motor vehicle starts.

In particular, there is provision for the proposed steering system circuit arrangement to be used in an electromechanical steering system. In particular, in order to achieve the object cited at the outset, there is therefore also provision for an electromechanical steering system, in particular a steer-by-wire steering system, that comprises a steering shaft, by way of which a steering command is able to be provided by means of a steering handle, and a steering adjuster having at least one electric motor, in particular having one electric motor or having two electric motors, and having a circuit arrangement for operating the at least one electric motor, the steering adjuster being designed to use the electric motor to convert a steering command into a steering movement for steerable wheels of a motor vehicle. The circuit arrangement is a steering system circuit arrangement proposed according to the present disclosure that, in particular, has the features described hereinabove individually or in combination.

The method moreover proposed for producing an electromechanical steering system with a first scope of functions or for producing an electromechanical steering system with a second scope of functions, the steering system comprising a steering shaft, by way of which a steering command is able to be provided by means of a steering handle, and a steering adjuster having at least one electric motor and having a circuit arrangement for operating the electric motor, and the steering adjuster being designed to use the electric motor to convert a steering command into a steering movement for steerable wheels of a motor vehicle, provides for the circuit arrangement used to be a steering system circuit arrangement proposed according to the present disclosure that, in particular, has the features described hereinabove individually or in combination. The steering system circuit arrangement is advantageously equipped with the first sensor unit in order to produce the electromechanical steering system with the first scope of functions, and the steering system circuit arrangement is advantageously equipped with the second sensor unit in order to produce the electromechanical steering system with the second scope of functions. Advantageously, the steering system circuit arrangement remains otherwise unchanged. In particular, the control unit remains unchanged and advantageously need not be replaced or adjusted for the sensor unit. In particular, there is provision for the first scope of functions to comprise steering angle determination by way of a rotor position sensor and for the second scope of functions to comprise steering angle determination by way of a rotor position sensor and additionally determination of the number of revolutions of the motor shaft, in particular by means of an index sensor. The first sensor unit therefore in particular has a rotor position sensor, and the second sensor unit in particular has a rotor position sensor and an index sensor.

In addition, as a further aspect of the present disclosure, there is provision for a method for operating an electromechanical steering system having a steering system circuit arrangement proposed according to the present disclosure that in particular has the features described hereinabove individually or in combination. The electromechanical steering system in particular comprises a steering shaft, by way of which a steering command is able to be provided by means of a steering handle, and a steering adjuster having at least one electric motor and having the steering system circuit arrangement according to the present disclosure for operating the at least one electric motor, the steering adjuster being designed to use the at least one electric motor to convert a steering command into a steering movement for steerable wheels of a motor vehicle. The method for operating the electromechanical steering system provides for the control unit of the steering system circuit arrangement to transmit a request to the sensor unit of the circuit arrangement for provision of input signals that go beyond the first input signals; if a response to the request is not received then the control unit provides the actuation signal by taking account of the first input signals; and if a response is received then the control unit determines the actuation signal by taking account of the further input signals that go beyond the first input signals in addition to the input signals corresponding to the first input signals. In particular, there is provision for this request to be sent to the sensor unit at a single time. To avoid data transmission errors, there is in particular provision for the request to be transmitted repeatedly at this single time. As such, the time is in particular a time interval, which may in particular comprise several seconds. After this time and the successful demand, the control unit is then advantageously either configured to operate with the first sensor unit, in particular if a response to the demand is not received, or configured to operate with the second sensor unit, in particular if the control unit receives a response. In particular for the purpose of performing an availability test for sensors of a respective sensor unit, however, there may also be provision for the control unit of the steering system circuit arrangement to transmit a request to the sensor unit of the circuit arrangement for provision of input signals that go beyond the first input signals at predefined intervals of time and/or upon predefined events, such as in particular at a service appointment or when the motor vehicle is started, with a received response being compared in particular with a last received response. If the received response is different from the last received response, or if a response is not received at all, a malfunction is advantageously detected. Advantageously, the control unit is configured so as, if only input signals for a second sensor unit that correspond to the first input signals are received, to continue to actuate the at least one electric motor in a reduced-function emergency mode.

In the various figures, identical parts are typically provided with the same reference signs and are therefore sometimes also each explained only in association with one of the figures.

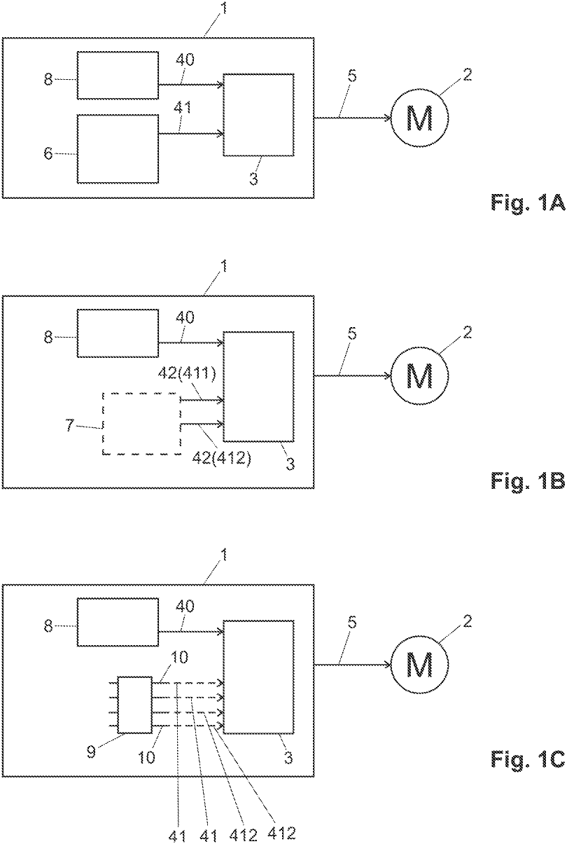

FIG. 1a and FIG. 1b each show an exemplary embodiment of a steering system circuit arrangement 1 configured according to the present disclosure. The steering system circuit arrangement 1 is designed for operating an electric motor 2 comprised by a steering adjuster, the circuit arrangement 1 comprising a control unit 3 and an optional third sensor unit 8. The control unit 3 is in particular an appropriately programmed microcontroller unit (MCU.). The circuit arrangement 1 in the exemplary embodiment shown in FIG. 1a moreover comprises a first sensor unit 6 and the circuit arrangement 1 in the exemplary embodiment shown in FIG. 1b moreover comprises a second sensor unit 7 instead of the first sensor unit 6.

The sensor units 6, 7, 8 are each designed to provide input signals 40, 41, 42 for the control unit 3, the control unit 3 being designed to receive the provided input signals 40, 41, 42 and to provide an actuation signal 5 for the electric motor 2 by taking account of the received input signals 40, 41, 42, in particular so that a provided steering command is converted into a steering movement for steerable wheels by way of assistance from the electric motor 2. In particular, there is provision for the third sensor unit 8 to comprise a torque sensor for measuring a torque applied to a steering shaft of a steering system and/or a torque sensor for measuring a torque applied to a steering pinion of a steering adjuster, the third sensor unit 8 in that case being designed to provide signals representing torques applied to the steering shaft as third input signals 40.

The first sensor unit 6 of the circuit arrangement 1 shown in FIG. 1a is designed to provide first input signals 41, there being in particular provision for the first input signals 41 to be signals representing a position of a motor shaft of the electric motor 2 that in particular allow assessment of a steering angle of the steered wheels. In particular, the first sensor unit 6 comprises a rotor position sensor for providing the first input signals 41. However, there may in particular be provision for the first sensor unit 6 to comprise further sensors or one or more other sensors.

The second sensor unit 7 of the circuit arrangement 1 shown in FIG. 1b is designed to provide second input signals 42, which are different from the first input signals 41. The second input signals 42 provided by the second sensor unit 7 comprise input signals 411 corresponding to the first input signals 41 and additionally further input signals 412 not provided by the first sensor unit 6. In particular, there is provision for the second input signals 411 corresponding to the first input signals 41 to be signals representing a position of a motor shaft of the electric motor 2 that in particular allow assessment of a steering angle of the steered wheels. In particular, the second sensor unit 7 comprises a rotor position sensor for providing the second input signals 411. Furthermore, there is in particular provision for the further input signals 412 provided by the second sensor unit 7 to be signals representing a number of revolutions of a motor shaft of the electric motor 2, in particular so that the control unit 3 is able to use said signal together with the input signals 411 to determine the position of the motor shaft absolutely and hence a steering angle of steered wheels in an improved manner. The second input signals 42 provided by the second sensor unit 7 therefore differ from the first input signals provided by the first sensor unit 6 in respect of the number and in some cases in respect of the representing measured variable. It is pointed out that in particular there may also be provision for the second sensor unit 7 to comprise further sensors or one or more other sensors, as described above.

The control unit 3 of the circuit arrangements 1 in the exemplary embodiments shown in FIG. 1a and FIG. 1b is of the same design in each case. As such, the control unit 3 has in particular the same hardware and the same software. The control unit 3 is both designed to receive the first input signals 41 provided by the first sensor unit 6 and to provide the actuation signal 5 by taking account of these received first input signals 41, and designed to receive the second input signals 42 provided by the second sensor unit 7 and to provide the actuation signal 5 by taking account of these received second input signals 42. The control unit 3 is designed to detect whether the circuit arrangement 1 comprises the first sensor unit 6 or the second sensor unit 7. In particular, the control unit 3 is designed to interact with sensor units from a specific set of sensor units, the sensor units in particular each differing in terms of the number of input signals provided. In order to detect the respective sensor unit, the control unit 3 is designed to demand every potential input signal from a sensor unit from the specific set of sensor units. If the demanded input signal is present, a response is transmitted. If the demanded input signal is not present, no response is transmitted.

Based on the exemplary embodiments shown in FIG. 1a and FIG. 1b, there may be provision for the sensor unit 6 to be a basic sensor unit, that is to say the first input signals 41, or input signals 411 corresponding to the first input signals 41, are assumed to be available. To detect whether the circuit arrangement 1 comprises the first sensor unit 6 or the second sensor unit 7, the control unit 3 transmits a request to the respective sensor unit 6, 7 for provision of input signals 41 that go beyond the first input signals 41, 411. In the case of the circuit arrangement 1 shown in FIG. 1a, no response is transmitted, because the sensor unit 6 is unable to provide the input signals 412. The control unit 3 therefore provides the actuation signal 5 by taking account of the first input signals 41 from the first sensor unit 6 and the additionally received third input signals 40. In the case of the circuit arrangement 1 shown in FIG. 1b, the control unit 3 receives the further input signals 412 in response to the request. The control unit 3 therefore provides the actuation signal 5 by taking account of the second input signals 411 corresponding to the first input signals 41 and the further input signals 412 from the second sensor unit 7 and the additionally received third input signals 40. The control unit 3 is thus designed to evaluate the received and unreceived responses in order to ascertain which sensor unit is involved, and is configured to use the respective available input signals to determine the actuation signal 5 and to provide said actuation signal for actuating the electric motor 2.

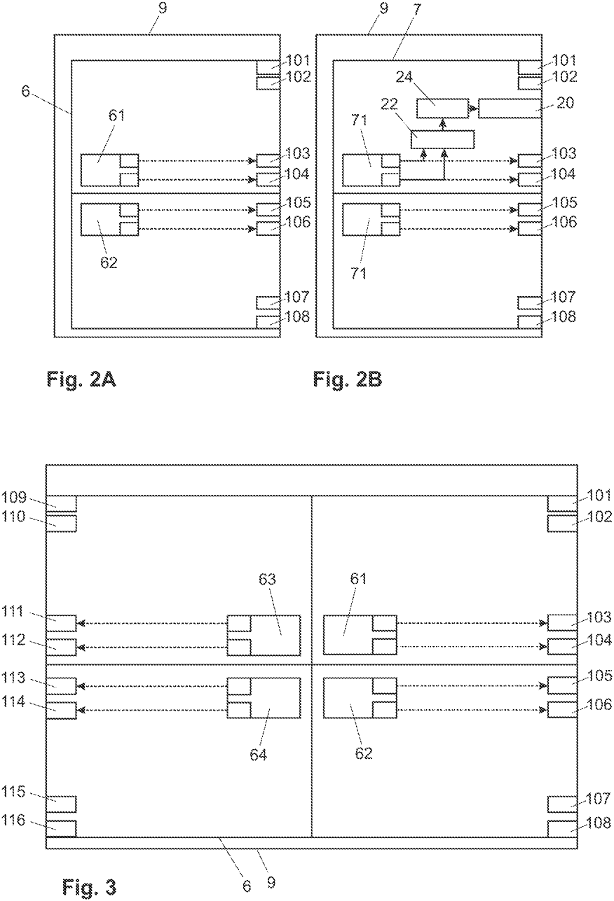

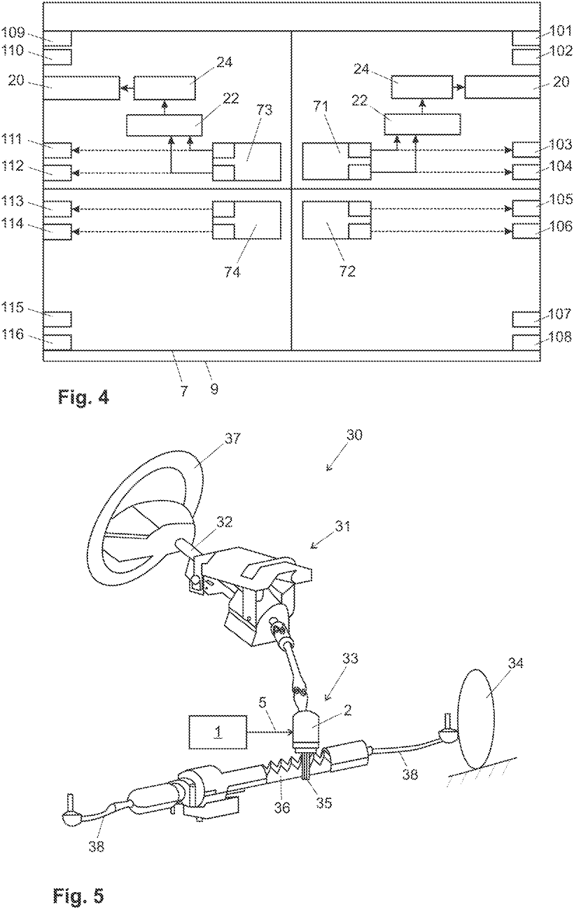

In the exemplary embodiment shown in FIG. 1c, the circuit arrangement 1 comprises an integrated circuit 9. The integrated circuit 9 comprises the first sensor unit 6 or the second sensor unit 7. The integrated circuit 9 has a plurality of defined outputs 10, the outputs 10 being used in particular to provide the input signals 41, 412 made available by the respective sensor unit. Possible advantageous configurations for the integrated circuit, subsequently also called IC for short, are shown in FIG. 2A, FIG. 2B, FIG. 3 and FIG. 4. The ICs shown in FIG. 2A and FIG. 2B are intended for a circuit arrangement 1 for actuating an electric motor 2 and have the defined outputs 103 to 106. The ICs shown in FIG. 3 and FIG. 4 are intended for a circuit arrangement 1 for actuating two electric motors 2 and have the defined outputs 103 to 106 and 111 to 114. 101, 102 and 107, 108 and 109, 110 and 115, 116 are the connections for the supply voltage, VCC and GND, respectively.

FIG. 2A shows an exemplary embodiment in which the IC comprises a first sensor unit 6 having a first rotor position sensor 61 and a redundant second rotor position sensor 62. The outputs 103, 104 are used by the first rotor position sensor 61 to provide sine or cosine signals representing the rotor position as analogue signals. The second rotor position sensor 62 accordingly provides redundant sine or cosine signals representing the rotor position as analogue signals via the outputs 105, 106.

In the exemplary embodiment shown in FIG. 2B, on the other hand, the IC comprises a second sensor unit 7. This second sensor unit 7 also has a first rotor position sensor 71 and a redundant second rotor position sensor 72, which, like the rotor position sensors 61, 62, provide sine or cosine signals representing the rotor position as analogue signals via the outputs 103, 104, or 105, 106. Unlike the first sensor unit 6, however, the second sensor unit 7 additionally has an analogue-to-digital converter 22, a revolution counter 24 and a digital interface 20, in particular a serial peripheral interface (SPI). The analogue-to-digital converter 22 converts the analogue sine and cosine signals provided by the first rotor position sensor 71 into digital signals and transmits them to the revolution counter 24, which is used to determine the absolute number of revolutions of the motor shaft of the electric motor 2 and to provide it as a further input signal via the interface 20.

In particular, there is provision for the control unit 3 of a steering system circuit arrangement 1 to be the same regardless of whether the IC is configured as in FIG. 2A or as in FIG. 2B. When the circuit arrangement 1 is activated, in particular when a motor vehicle is started, the control unit 3 of the circuit arrangement 1 transmits a data packet to the respective sensor unit 6, 7. In the case of the exemplary embodiment shown in FIG. 2B, the interface 20 of the sensor unit 7 provides the signal representing the number of revolutions as a digital input signal 412 and transmits it to the control unit 3. The control unit 3 accepts the value transmitted with this input signal 412, the value being updated by the control unit 3 during further operation on the basis of the input signals 411 provided by the rotor position sensors 71, 72, with the result that the input signal 412 does not need to be transmitted again, in particular before the motor vehicle is restarted. If no signal is provided via the interface 20 in response to the transmission of the data packet to the sensor unit 7, the control unit 3 detects an error. Moreover, the control unit 3 detects an error when the value of the input signal 412 transmitted by the interface 20 is lower than the most recently transferred value.

The sensor units 6, 7 of the ICs 9 according to the exemplary embodiments shown in FIG. 3 and FIG. 4 are each designed for a circuit arrangement that is used to operate two electric motors 2. Accordingly, the elements of the sensor units 6, 7, as described in association with the exemplary embodiments shown in FIG. 2A and FIG. 2B, are each present in duplicate.

FIG. 5 shows an exemplary embodiment of an electromechanical steering system 30 designed according to the present disclosure for a motor vehicle, in particular for a passenger vehicle. FIG. 5 uses a simplified perspective representation to provide an overview of the steering system 30.

The steering system 30 comprises a steering column 31 having a steering shaft 32. The steering shaft 32 is mechanically coupled to the steerable wheels 34 of a motor vehicle by way of a steering link 33. In this exemplary embodiment, the steering link 33 comprises a pinion 35, which is able to be driven by an electric motor 2, and a toothed coupling bar 36, also called a gear rack, the steering link 33 being used to translate a rotational movement of the pinion 35 into a translational movement of the gear rack 36 along the longitudinal axis of the latter. Arranged in a rotationally fixed manner at the end of the steering shaft 32 that faces a driver is a steering wheel as a steering handle 37 for inputting a steering command, a driver being able to turn the steering handle 37 in a known manner in order to input a steering command. In this exemplary embodiment, the gear rack 36, which moves linearly along its longitudinal axis, is mechanically coupled to a tie rod 38 on each of the two sides of the motor vehicle. The tie rods 38 are in turn each mechanically coupled to the vehicle wheels 34. The steering link 33 is therefore designed to use appropriate actuation of the electric motor 2 by means of a steering system circuit arrangement 1 provided for that purpose to convert a steering command into a steering movement for the steerable wheels 34 of a motor vehicle by taking account of at least one input variable. The circuit arrangement 1 is in particular designed as explained with reference to the preceding exemplary embodiments.

The electromechanical steering system 30 may be equipped with various functions, for example a so-called sleep mode. The steering system circuit arrangement 1 is equipped with a first sensor unit 6, in particular with an IC 9 comprising the first sensor unit 6, in order to produce the electromechanical steering system 30 with a first scope of functions, and the steering system circuit arrangement 1 is equipped with a second sensor unit 7, in particular with an IC 9 comprising the second sensor unit 7, in order to produce the electromechanical steering system 30 with a second scope of functions. That is to say that it is merely necessary to use the IC 9 having the applicable sensor unit 6, 7 without having to make further adjustments to the circuit arrangement 1.

The exemplary embodiments shown in the figures and explained in association therewith are used to explain the present disclosure and are not restrictive therefor.

List of reference signs

| | |
|---|---|
| 1 | steering system circuit arrangement |
| 2 | electric motor |
| 3 | control unit |
| 40 | third input signals |
| 41 | first input signals |
| 42 | second input signals |
| 411 | second input signals corresponding to the first input signals |
| 412 | further second input signals |
| 5 | actuation signal |
| 6 | first sensor unit |
| 61 | first rotor position sensor of the first sensor unit (6) |
| 62 | second rotor position sensor of the first sensor unit (6) |
| 7 | second sensor unit |
| 71 | first rotor position sensor of the second sensor unit (7) |
| 72 | second rotor position sensor of the second sensor unit (7) |
| 8 | third sensor unit |
| 9 | integrated circuit |
| 10 | defined output |
| 101 | VDD1 |
| 102 | GND1 |
| 103 | sin1+ |
| 104 | cos1+ |
| 105 | sin2- |
| 106 | cos2- |
| 107 | VDD2 |
| 108 | GND2 |
| 109 | VDD3 |
| 110 | GND3 |
| 111 | sin3+ |
| 112 | cos3+ |
| 113 | sin4- |
| 114 | cos4- |
| 115 | VDD4 |
| 116 | GND4 |
| 20 | interface |
| 22 | analogue-to-digital converter |
| 24 | revolution counter |
| 30 | electromechanical steering system |
| 31 | steering column |
| 32 | steering shaft |
| 33 | steering adjuster |
| 34 | steerable wheel |
| 35 | steering pinion |
| 36 | gear rack |
| 37 | steering handle |
| 38 | tie rod |

What is claimed is:

1. A steering system circuit arrangement for operating an electric motor comprised by a steering adjuster, the steering system circuit arrangement comprising:
a control unit that is configured to provide an actuation signal for the electric motor; and
a first sensor unit that is configured to provide first input signals or a second sensor unit that is configured to provide second input signals that are different from the first input signals,
wherein the control unit is configured:
to receive the first input signals provided by the first sensor unit and to provide the actuation signal by taking into account the first input signals that are received, and
to receive the second input signals provided by the second sensor unit and to provide the actuation signal by taking into account the second input signals that are received.

2. The steering system circuit arrangement of claim 1 wherein the second input signals provided by the second sensor unit differ at least partially from the first input signals provided by the first sensor unit in respect of at least one of a number, a representing measured variable, or a type of output.

3. The steering system circuit arrangement of claim 1 wherein the second input signals comprise input signals that correspond to the first input signals and additional input signals.

4. The steering system circuit arrangement of claim 3 wherein the first sensor unit and the second sensor unit are each configured to provide a signal representing a position of a motor shaft as the first input signals or as input signals corresponding to the first input signals.

5. The steering system circuit arrangement of claim 4 wherein the second sensor unit is configured to provide a number of revolutions of a motor shaft as the additional input signals.

6. The steering system circuit arrangement of claim 3 wherein the control unit is configured to perform a function check based on the additional input signals.

7. The steering system circuit arrangement of claim 3 comprising an integrated circuit that comprises the first sensor unit or the second sensor unit.

8. The steering system circuit arrangement of claim 7 wherein the integrated circuit comprises defined connections for providing the first input signals or the second input signals.

9. The steering system circuit arrangement of claim 7 wherein the integrated circuit comprises the second sensor unit and an interface for providing the additional input signals.

10. The steering system circuit arrangement of claim 1 wherein the control unit is configured to detect whether the steering system circuit arrangement comprises the first sensor unit or the second sensor unit.

11. The steering system circuit arrangement of claim 1 wherein the control unit is configured to perform an initialization that includes checking whether the first input signals or the second input signals are provided.

12. An electromechanical steering system comprising:
a steering shaft, by way of which a steering command can be provided with a steering handle; and
a steering adjuster having an electric motor and a circuit arrangement for operating the electric motor, the steering adjuster being configured to use the electric motor to convert a steering command into a steering movement for steerable wheels of a motor vehicle, wherein the circuit arrangement comprises:
a control unit that is configured to provide an actuation signal for the electric motor, and
a first sensor unit that is configured to provide first input signals or a second sensor unit that is configured to provide second input signals that are different from the first input signals,
wherein the control unit is configured:
to receive the first input signals provided by the first sensor unit and to provide the actuation signal by taking into account the first input signals that are received, and
to receive the second input signals provided by the second sensor unit and to provide the actuation signal by taking into account the second input signals that are received.

13. A method for operating the electromechanical steering system of claim 12, the method comprising:
transmitting with the control unit a request to the sensor unit of the circuit arrangement for provision of additional input signals that go beyond the first input signals;
providing with the control unit the actuation signal by taking into account the first input signals when a response to the request is not received;
providing with the control unit the actuation signal by taking into account the additional input signals that go beyond the first input signals in addition to the input signals corresponding to the first input signals when a response to the request is received.

14. A method for producing an electromechanical steering system with a first scope of functions or a second scope of functions, the electromechanical steering system comprising a steering shaft by way of which a steering command can be provided with a steering handle, a steering adjuster having an electric motor and having a circuit arrangement for operating the electric motor, the steering adjuster being configured to use the electric motor to convert a steering command into a steering movement for steerable wheels of a motor vehicle, wherein the circuit arrangement is the steering system circuit arrangement of claim 1, the steering system circuit arrangement being equipped with the first sensor unit to produce the electromechanical steering system with the first scope of functions and the steering system arrangement being equipped with the second sensor unit to produce the electromechanical steering system with the second scope of functions.
